(19) United States
(12) Patent Application Publication
(10) Pub. No.: US 2017/0039138 A1
(43) Pub. Date: Feb. 9, 2017

(54) INFORMATION PROCESSING SYSTEM, INFORMATION PROCESSING METHOD, AND RECORDING MEDIUM STORING AN INFORMATION PROCESSING PROGRAM

(71) Applicant: Hideki TODA, Tokyo (JP)

(72) Inventor: Hideki TODA, Tokyo (JP)

(73) Assignee: Ricoh Company, Ltd., Tokyo (JP)

(21) Appl. No.: 15/219,630

(22) Filed: Jul. 26, 2016

(30) Foreign Application Priority Data
Aug. 5, 2015 (JP) 2015-155175

(51) Int. Cl. G06F 12/0842

(52) U.S. Cl. CPC G06F 12/0842; G06F 2212/1024; G06F 2212/452; G06F 2212/281; G06F 2212/608

(57) ABSTRACT

An information processing system includes circuitry that executes multiple threads that, in converting data, concurrently performs calculation required for a data conversion on an attribute including a type of the data and a memory that stores the attribute associated with a converted value obtained by the calculation. The memory includes a storage area for the attribute, allocated to each of the multiple threads and to store the attribute associated with a value indicating an address that stores the converted value corresponding to the attribute and a storage area for the converted value, to be shared by all of the multiple threads and store the attribute associated with the converted value obtained by the calculation.

### CROSS-REFERENCE TO RELATED APPLICATION

This patent application is based on and claims priority pursuant to 35 U.S.C. §119(a) to Japanese Patent Application No. 2015-155175, filed on Aug. 5, 2015 in the Japan Patent Office, the entire disclosure of which is hereby incorporated by reference herein.

### BACKGROUND

Technical Field

The present invention relates to an information processing system, an information processing method, and a non-transitory recording medium storing an information processing program.

Background Art

If a conversion process is performed on an original value (hereinafter referred to as a tag value), the conversion result is cached associated with the tag value in order to enhance processing performance. If the same tag value is used in subsequent operations, it is possible to skip the conversion process by using the cached conversion result. Likewise, it is also possible to enhance processing performance in multi-threading by managing the cache.

In multi-threading, if tag values handled in each thread have a similar tendency, it is effective to share one cache with all threads. Here, the thread is a minimum unit of a program on an operating system (OS) that supports concurrent processing in the field of software and programming etc., and multi-threading means that multiple threads are executed simultaneously to perform operations concurrently.

For example, in multi-threaded rendering (MTR), drawing processes are performed concurrently on mini bands obtained by dividing a band by the number of threads. In standard image data, object attributes (i.e., tag values) of adjacent coordinates usually become congruent with each other. However, in MTR, since the drawing process is performed on mini bands that are divided by thread and whose coordinate areas are different from each other, tendency of object attributes (tag values) handled for each thread usually becomes different. In this case, it is effective to have a unique cache for each thread separately.

In multi-threading, depending on tendency of handled tag values, technologies that use shared cache only in all threads, use caches dedicated to each thread only, and either one of the technologies described above is used are known.

For example, a technology that shares one cache with multiple modules to prevent cache efficiency among multiple modules from deteriorating is disclosed.

### SUMMARY

Example embodiments of the present invention provide a novel information processing system that includes circuitry that executes multiple threads that, in converting data, concurrently performs calculation required for a data conversion on an attribute including a type of the data and a memory that stores the attribute associated with a converted value obtained by the calculation. The memory includes a storage area for the attribute, allocated to each of the multiple threads and to store the attribute associated with a value indicating an address that stores the converted value corresponding to the attribute and a storage area for the converted value, to be shared by all of the multiple threads and store the attribute associated with the converted value obtained by the calculation.

Further example embodiments of the present invention provide a method of processing information and a non-transitory recording medium storing an information processing program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating functional blocks of an image processing system as an embodiment of the present invention.

FIG. 2 is a diagram illustrating hardware blocks of an image processing system as an embodiment of the present invention.

FIG. 3 is a diagram illustrating a multi-threading process and cache management in an image forming controller included in the image processing system as an embodiment of the present invention.

FIG. 4 is a diagram illustrating cache management that uses a shared cache array only in all threads in a known image processing system.

FIG. 5 is a diagram illustrating cache management that uses a cache array dedicated to each thread only in a known image processing system.

FIG. 6 is a diagram illustrating cache management that uses both the tag value cache dedicated to each thread and the shared cache data array only in all threads as an embodiment of the present invention.

FIGS. 7A and 7B are flowcharts illustrating an operation of the cache management that uses both the tag value cache dedicated to each thread and the shared cache data array only in all threads as an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

A more complete appreciation of the disclosure and many of the attendant advantages thereof will be readily obtained as the same becomes better understood by reference to the following detailed description when considered in conjunction with the accompanying drawings.

Embodiments of the present invention are described below in detail with reference to figures. In figures, same symbols are assigned to same or corresponding parts, and their descriptions are simplified or omitted appropriately.

In the known technologies, in case of managing a cache validating either one of the two cache types in multi-threading, the tendency of the tag values does not stay constant since the tendency of the tag values depends on processed data. In addition, in using the shared cache only with all threads, if the tendency of the processed tag values is unequal, the tag values dedicated to each thread are also shared, and that results in causing waste in searching. Furthermore, in using the cache dedicated to each thread only, if the tendency of processed tag values is similar, since it is required to allocate separate caches for same tag values that should have been shared, that results in causing waste of a memory size.

In the known technology, a printed document converting apparatus uses shared cache data in multi-threading. However, in using the shared cache only as described above, if the tendency of the processed tag values is unequal, the dedicated tag values that can be used in each thread only are also targets to be searched for all threads. As a result, the problem that efficiency of searching through cache deteriorates still remains.

In the embodiment described below, an image processing system is described as an example of managing a cache in multi-threading. However, the embodiment can be applied to various systems that manages a cache in multi-threading.

In this embodiment, regarding the cache management in multi-threading, following points are described. More specifically, in converting predetermined data, a cache management for converted values in multiple thread processes that performs required calculation concurrently. It should be noted that, in this case, multi-threading indicates an operation that converts data by processing multiple number of threads concurrently.

First, calculation required for the data conversion is performed on an attribute including types of predetermined data etc. In this case, the attribute and the converted value acquired by the calculation required for the data conversion are stored in a memory such as a cache memory associated with each other. Subsequently, if a new attribute appears, it is determined whether or not the new attribute is stored in the memory.

Furthermore, if it is determined that the new attribute is stored in the memory, the conversion value stored in the memory associated with the new attribute is used without performing the calculation required for the data conversion. After that, as a storage area of the memory, two types of arrays, one is a tag value array dedicated to each thread (value indicating a tag value and an address in a cache data value array), and the other is a cache data value array shared by all threads, are used. As a result, it is possible to manage the cache in multi-threading efficiently.

By using the tag value array dedicated to each thread, it is possible to provide the most appropriate cache to each thread and perform searching at high speed compared to a conventional method that uses the cache shared by all threads only. In addition, by using the cache data value array that stores data for the same tag value commonly, it is possible to minimize the memory size.

Compared to the conventional method that uses the cache shared by all threads only, while the memory size becomes larger for the tag value array dedicated to each thread, the size of the tag value array becomes smaller normally compared to the cache data value array. For example, while 1 entry of the tag value array corresponds to 2 bytes, 1 entry of the cache data value array corresponds to several dozen bytes. As a result, it is possible to reduce the memory size compared to the conventional method that uses the cache shared by all threads only.

In addition, in the conventional method that uses the cache shared by all threads only, even in case of the same tag value, since it is managed separately for each thread, for each thread. Consequently, a cost of calculation from the same tag value into the conversion result is required. By contrast, in this embodiment, since the conversion result is shared by using the cache data value array, it is required to perform the calculation from the tag value into the conversion result only once in the beginning. The embodiments of the present invention are described below in detail with reference to figures.

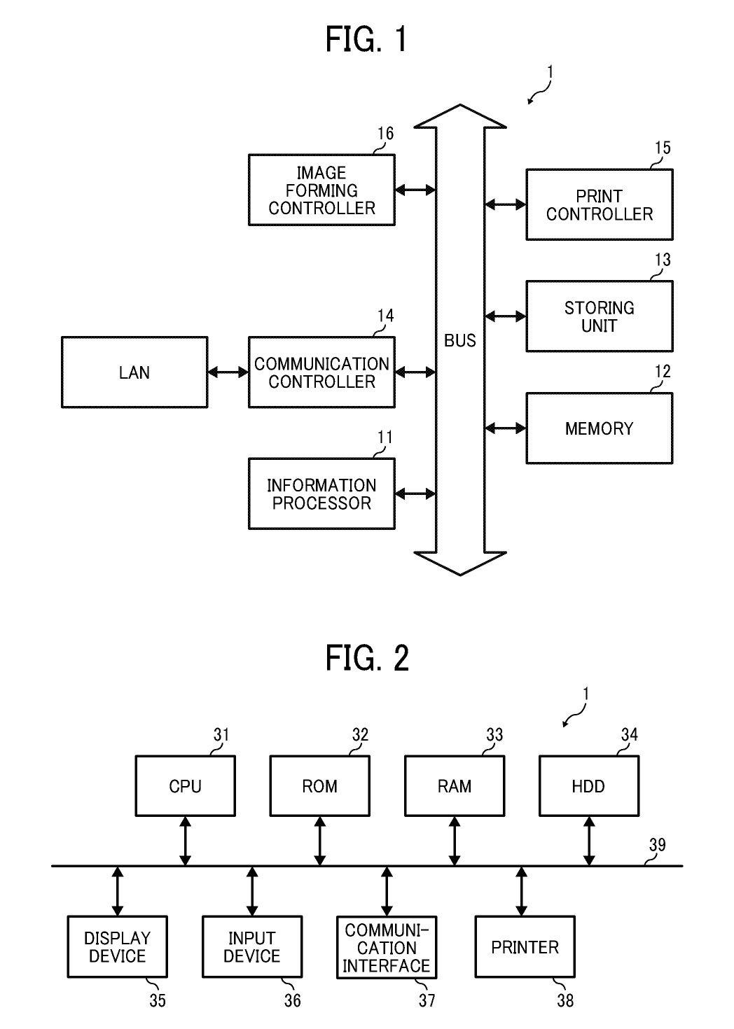

First, a schematic configuration of an image processing system in this embodiment is described below. FIG. 1 is a diagram illustrating functional blocks of an image processing system in this embodiment.

In FIG. 1, in the image processing system 1, print data written in a page description language is interpreted, converted into a bitmap image, and printed on recording paper. The image processing system 1 includes an information processor 11 that controls the whole system, a memory 12 that is used as a work area, and a storing unit 13 that is used for storing image data and a program.

A communication controller 14 that receives a command such as image data via a local area network (LAN) and transfers data in response to the command is included as one of controllers. In addition, a print controller 15 that interprets data such as the received data performs drawing data etc. is included. Furthermore, an image forming controller 16 that controls a print engine that forms an image on the recording paper using the drawing data is included. It is possible to transfer data among the controllers via a bus.

The communication controller 14, the print controller 15, and the image forming controller 16 performs operations by driving modules required for the control. In addition, to achieve efficiency of control, multi-threading is adopted for modules in the controllers in some cases.

Next, a schematic configuration of an image processing system in this embodiment is described below. FIG. 2 is a diagram illustrating hardware blocks of an image processing system in this embodiment.

In FIG. 2, the image processing system 1 includes a central processing unit (CPU) 31 that controls the entire image processing system 1 and a read only memory (ROM) 32 that stores a program that the CPU 31 executes. In addition, the image processing system 1 includes a random access memory (RAM) 33 as a work memory for the program that the CPU 31 executes and a hard disk drive (HDD) 34 that stores the image data etc.

Furthermore, the image processing system 1 includes an input device 36 as an operational unit of the image processing system 1 and a user interface and a display device 35 that includes a liquid crystal display (LCD) etc. If the input device 36 includes a touch panel configuration, the display device 35 also functions as the user interface.

Furthermore, the image processing system 1 includes a communication interface 37 that exchanges data via the LAN etc. and a printer 38 that processes the drawing data etc. to form an image on the recording paper using the drawing data. Lastly, the above components included in the image processing system 1 are connected with each other via a bus 39.

It should be noted that the information processor 11 in FIG. 1 is implemented by the CPU 31 and the communication controller 14 in FIG. 1 is implemented by the communication interface 37. In addition, the image forming controller 16 and the print controller 15 in FIG. 1 are implemented by the CPU 31 and the printer 38, the memory 12 in FIG. 1 is implemented by the ROM 32 and the RAM 33, and the storing unit 13 in FIG. 1 is implemented by the HDD 34.

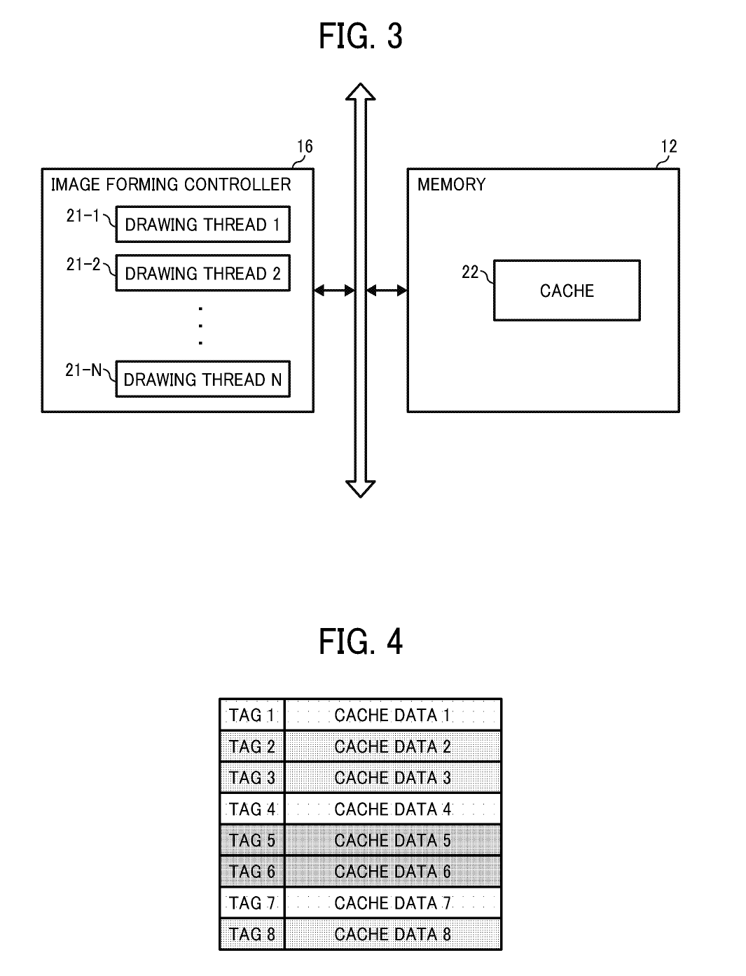

Next, a multi-threading process and cache management in the image forming controller included in the image processing system in this embodiment is described below. FIG. 3 is a diagram illustrating a multi-threading process and cache management in the image forming controller included in the image processing system in this embodiment.

Here, the multi-threading process by the image forming controller 16 in FIG. 1 is described as an example. However, the embodiment can be applied to the multi-threading process and the cache management by any controller (module). After receiving the image data, the image forming controller 16 converts the image data into a bitmap image using the memory 12 as the work area. To achieve efficiency of control, the multi-threading process is adopted for a control module in the image forming controller 16.

The control module of the image forming controller 16 executes drawing threads 21-1 to 21-N (i.e., the number of the drawing threads is N) and generates the bitmap image concurrently in each of the drawing threads. The drawing operation described above is known as multi-threaded rendering (MTR).

In converting the image data into the bitmap image, the drawing threads 21-1 to 21-N performs converting calculation required for the bitmap conversion on object attributes (tag values) such as a type (e.g., font, graphic, and image) and a drawing color value etc. Subsequently, to reuse the conversion result, the conversion result is stored in the cache 22 of the memory 12 associated with the object attribute (tag value).

Here, examples of the cache types are font cache, graphic cache, and image cache etc. Before drawing the object of the object attribute (tag value), the drawing threads 21-1 to 21-N searches through the cache 22 for the conversion value for the object attribute (tag value) to check whether or not the conversion result exists in the cache 22.

After searching through the cache 22, if the conversion value is included in the cache 22, the conversion result is reused. In this case, it is possible that the drawing threads 21-1 to 21-N omit the converting calculation required for the bitmap conversion on the object attribute (tag value).

After searching through the cache 22, if the conversion value does not exist in the cache 22, the drawing threads 21-1 to 21-N perform the converting calculation required for the bitmap conversion on the object attribute (tag value). Subsequently, to reuse the conversion result, the conversion result is stored in the cache 22 associated with the object attribute (tag value).

Conventionally, regarding the cache management in the multi-threading process, two types of the cache management exist, one uses the cache shared by all threads only, and the other uses the cache dedicated to each thread only.

Next, cache management that uses a shared cache array only in all threads in the known image processing system is described below. FIG. 4 is a diagram illustrating cache management that uses a shared cache array only in all threads in the known image processing system.

In FIG. 4, a case of two threads is taken as an example. However, it is possible to apply the embodiment to any case of N threads. In this cache management method, one cache array is shared with all threads. The order of registering cache array depends on frequency used by all threads, and the order of registering cache array is updated so that the cache value whose frequency in use is high is located at a higher position and searched firstly.

In FIG. 4, the tags 2, 3, and 8 are cache arrays used by thread 1 only. Therefore, in searching for the cache array for thread 2, the cache arrays for tags 2, 3, and 8 that is not used by thread 2 (i.e., used by thread 1 only) are also considered as the search targets, resulting in generating useless search.

In addition, the tags 5 and 6 are cache arrays used by thread 2 only. As a result, in searching for the cache array for thread 1, the cache arrays for tags 5 and 6 that is not used by thread 1 (i.e., used by thread 2 only) are also considered as the search targets, resulting in generating useless search.

Lastly, the tags 1, 4, and 7 are cache arrays used by all threads. Regarding tags 1, 4, and 7, an order of registration is updated depending on frequency in use of both thread 1 and thread 2 Since tag 1, 4, and 7 are not subjected to the frequency in use for each of the threads 1 and 2, the order of registration is not optimized for each thread.

In multi-threading, if tag values handled in each thread have a similar tendency, it is effective to manage the cache in the way described above. However, if the tendency of the processed tag values is unequal for each thread, it takes longer time to search through the cache array, resulting an issue.

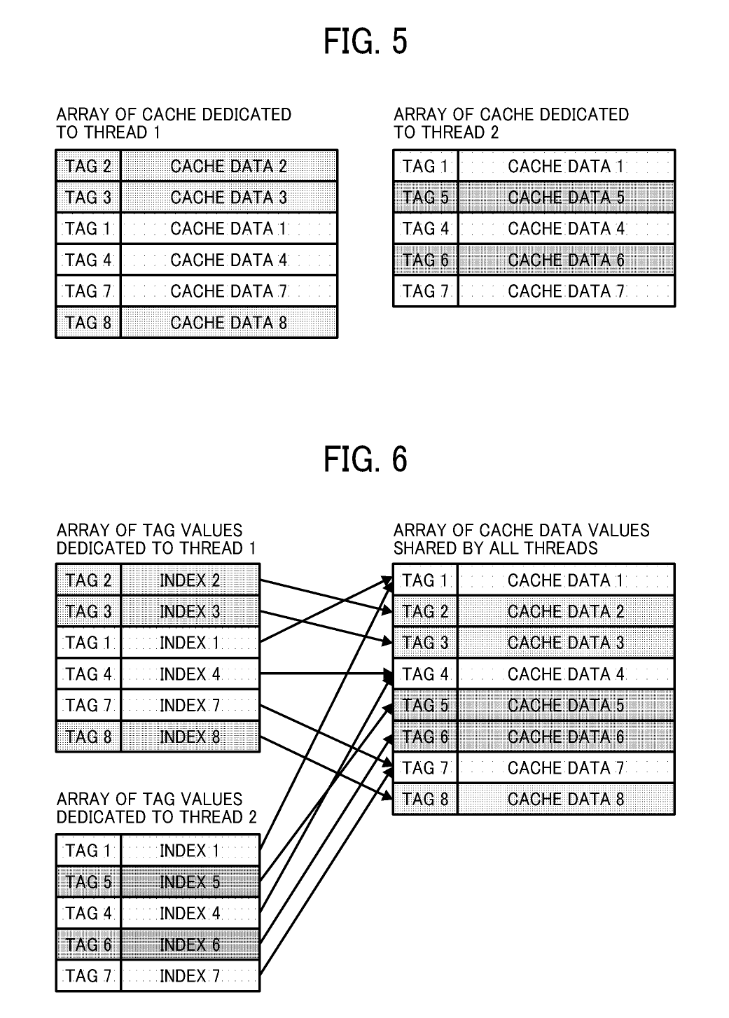

Next, cache management that uses a cache array dedicated to each thread only in a known image processing system is described below. FIG. 5 is a diagram illustrating cache management that uses a cache array dedicated to each thread only in a known image processing system.

In FIG. 5, a case of two threads is taken as an example. However, it is possible to apply the embodiment to any case of N threads. In this cache management method, dedicated cache arrays are managed separately in each thread.

Tag 1, 4, and 7 are cache arrays that are used for all threads, and a cache array dedicated to thread 1 and a cache array dedicated to thread 2 are managed separately. As a result, a cache array for each thread is allocated in a memory, resulting in consuming a large memory size.

In addition, if tag 1, 4, and 7 are cache arrays shared by threads 1 and 2, it is required to perform calculation from the tag value into the conversion result only once at the beginning. However, since the cache is managed separately in each thread, it takes cost to perform calculation to the conversion result in each thread, resulting an issue.

In multi-threading, if the tendency of the processed tag values is unequal for each thread, the cache management in FIG. 5 is effective. However, if the tendency of the processed tag values is similar, the memory size becomes larger and it takes more calculation in calculating from the tag values into the cache data as the conversion result, resulting an issue.

Next, cache management that uses both the tag value cache dedicated to each thread and the shared cache data array in all threads in the image processing system in this embodiment is described below. FIG. 6 is a diagram illustrating cache management that uses both the tag value cache dedicated to each thread and the shared cache data array in all threads in the image processing system in this embodiment.

In FIG. 6, a case of two threads is taken as an example. However, it is possible to apply the embodiment to any case of N threads. In the cache management described above, using the tag value array dedicated to each thread, it is possible to provide optimized cache data for each thread. In the tag value array, only tag values used in the thread in the past are registered, and the order of registration (i.e., the order of search) is optimized in accordance with the frequency in use for the thread. As a result, compared to the cache management in FIG. 4 that uses a shared cache array only in all threads in the known image processing system, it is possible to search through the cache at high speed.

In the cache management in FIG. 6, by using the cache data value array that stores data for the same tag value commonly, it is possible to minimize the memory size. Compared to the cache management in FIG. 4 that uses the shared cache array only in all threads, the memory size becomes larger for the tag value array. However, in usual cases, compared to the cache data value array, the size of the tag value array becomes smaller. For example, compared that one entry of the tag value array is two bytes, one entry of the cache data value array is several dozen bytes.

In addition, compared to the cache management in FIG. 5 that uses the cache array dedicated to each thread only in the known image processing system, it is possible to reduce the memory size. Furthermore, in the cache management in FIG. 5 that uses the shared cache array dedicated to each thread only, the same tag values are managed separately for each thread. As a result, it takes cost to perform the cache data as the conversion result from the same tag value for each of threads separately, resulting an issue.

By contrast, in the cache management in FIG. 6, since the conversion result is shared by using the cache data value array, it is required to perform the calculation from the tag value into the conversion result only once in the beginning. In multi-threading, it is possible to provide an optimized cache configuration in both cases that the tendency of tag values processed in each thread is similar and the tendency of tag values processed in each thread is unequal.

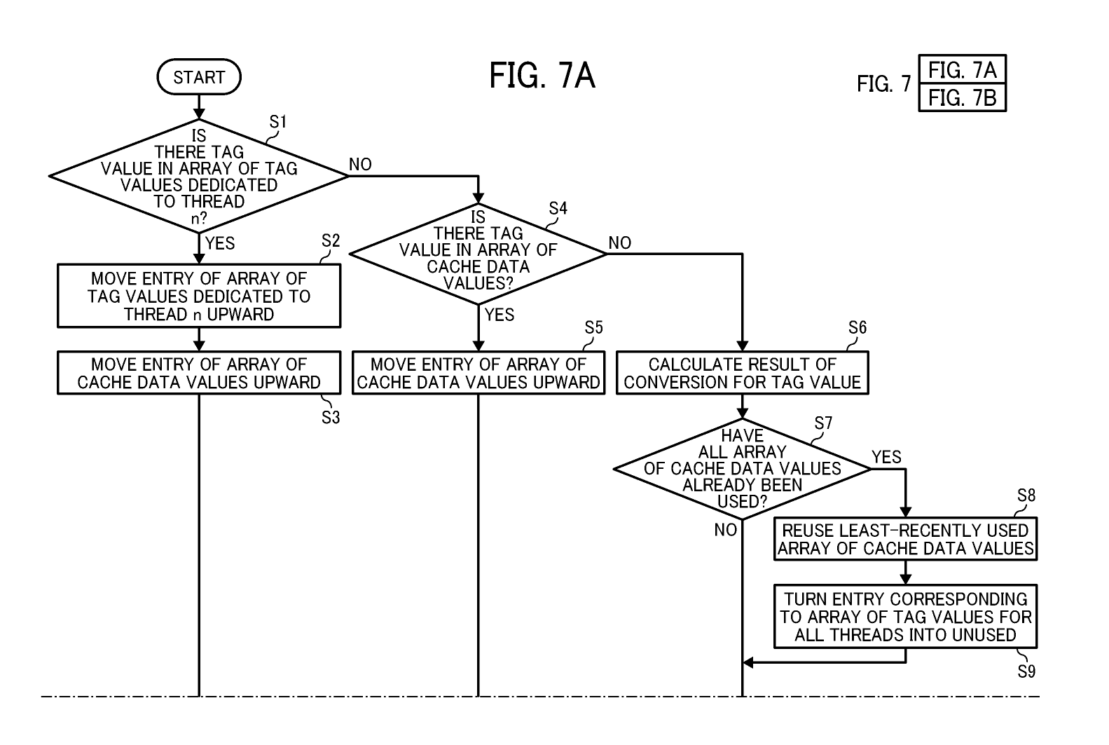

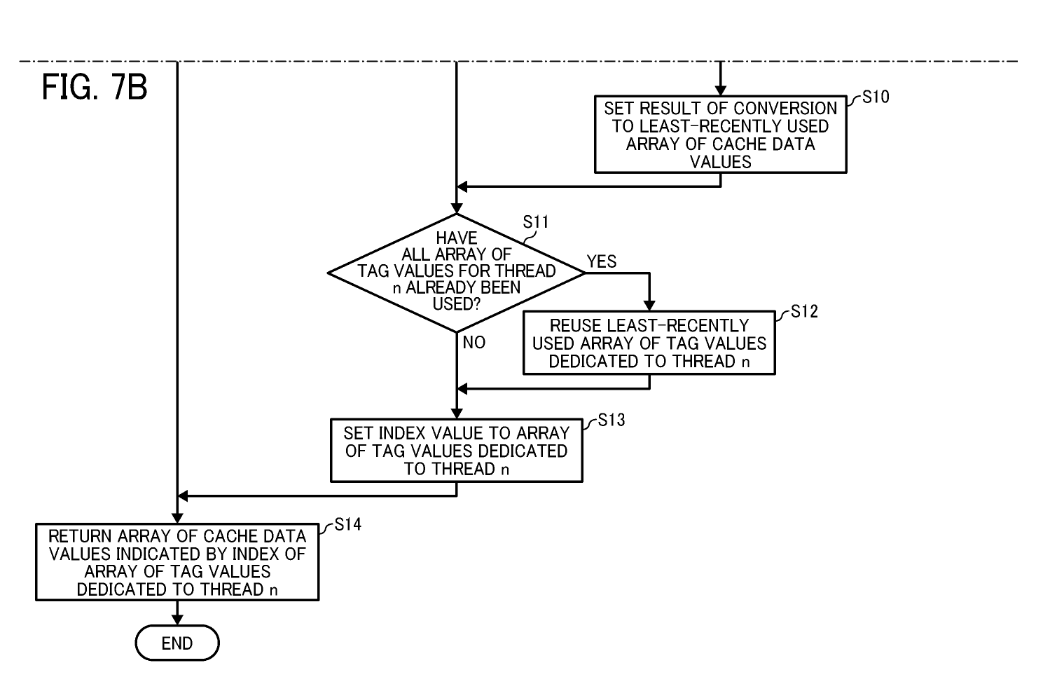

Next, a cache management operation that uses both the tag value cache dedicated to each thread and the shared cache data array in all threads in the image processing system in this embodiment is described below. FIGS. 7A and 7B are flowcharts illustrating an operation of the cache management that uses both the tag value cache dedicated to each thread and the shared cache data array only in all threads in this embodiment. Here, in thread n in multi-threading, an operation that performs conversion on a tag value and returns the conversion result is performed.

In S1, it is determined whether or not the tag value exists in a tag value array dedicated to thread n. In other words, it is searched through the tag value array for thread n whether or not the conversion result of the tag value is cached.

In this case, the tag value array is dedicated to thread n (left array in FIG. 6), only tag values used in the thread in the past are registered, and the order of registration (i.e., the order of search) is optimized in accordance with the frequency in use for thread n. As a result, the number of loops required for the search is minimized, and it is possible to search through the tag value array.

In S1, if the tag value exists in the tag value array dedicated to thread n (YES in S1), i.e., the conversion result has already been cached in the tag value array for thread n, it is possible to omit the conversion operation by using the cached conversion result. Subsequently, in S2, in the tag value array dedicated to thread n, current entries in the tag value array are moved upwards.

Furthermore, in S3, in the shared cache data value array, current entries of tag values are moved upwards. By the operations in S2 and S3, the entries in the tag value are moved upwards in the array. As a result, the entries are searched through more preferentially in the subsequence search, and the entries are difficult to be discarded even if all cache arrays become used.

In S1, if the tab value does not exist in the tag value array dedicated to thread n (NO in S1), i.e., the conversion result has not been cached in the tag value array for thread n yet, the step proceeds to S4. In S4, it is determined whether or not the tag value exists in the cache data value array. In other words, it is searched through the shared cache data value array whether or not the conversion result of the tag value is cached.

In S4, if the tag value exists in the cache data value array (YES in S4), i.e., the conversion result of the tag value has already been cached in the shared cache data value array, the conversion result cached by another thread is used. As a result, it is possible to omit the conversion operation. In the method that uses the cache dedicated to each thread only, it is managed for each thread separately for the same tag value. Therefore, in each thread, the cache data as the conversion result is calculated from the same tag value, resulting in increasing cost.

By contrast, in the cache management described above, since the conversion result is shared by using the cache data value array, it is required to perform the calculation from the tag value into the conversion result only once in the beginning. Furthermore, in S5, in the shared cache data value array, current entries of tag values are moved upwards. As a result, the subsequent searching priority is raised, and the entries are difficult to be discarded even if all cache arrays become used.

In S4, if the tag value does not exist in the cache data value array (NO in S4), i.e., the conversion result has not been cached in the shared cache data value array yet, the step proceeds to S6. In S6, the conversion operation is performed for the tag value to calculate the conversion result. Subsequently, it is tried to store the conversion result obtained in S6 in the shared cache data value array. Subsequently, in S7, it is determined whether or not the entries of the shared cache data value array are full, i.e., all of the cache data value array are used.

If all of the cache data value array are used in S7 (YES in S7), the step proceeds to S8. In S8, among the shared cache data value arrays, the cache data value array whose order of registration is the lowest, i.e., the frequency in use is the lowest, is reused. As a result, the previous conversion result (cache data value array) in the reused entry cannot be referred anymore. Therefore, in S9, corresponding entries of that tag value array indicating the entry are turned into unused.

By the operations in S7, S8, and S9, among the shared cache data value arrays, the entry whose frequency in use is the lowest including unused. Consequently, in S10, in the cache data value array whose frequency in use is the lowest, tag value is stored in the cache associated with the conversion result in S6. Here, by not registering the conversion result for the same tag value for each thread separately but registering the conversion result for the same tag value in the shared cache data value array for all threads, it is possible to minimize the memory size.

Subsequently, it is tried to associate the entries of the cache data value array for the tag value with the tag value array for thread n. In S11, it is determined whether or not the entries in the tag value array for thread n are full, i.e., all entries have already been used. In S11, if it is determined that all of the tag value array for thread n have already been used (YES in S11), the step proceeds to S12. In S12, among the tag value arrays for thread n, the tag value array dedicated to thread n whose order of registration is the lowest, i.e., whose frequency in use is the lowest, is reused.

By the operations in S11 and S12, in the tag value array for thread n, the entry whose frequency in use is the lowest including unused. As a result, in S13, in the tag value array dedicated to thread n, a value (index) indicating an address of the shared cache data value array is set. That is, the entry whose frequency in use is the lowest is stored in the cache associated with the tag value and a value (an index) indicating an address that stores cache data corresponding to the tag value in the shared cache data value array.

By performing the operations in steps S1 to S3, the cached entry corresponding to the tag value in the tag value array is determined. In S14, a cache data value array indicated by a value (an index) indicating an address that stores cache data corresponding to the tag value in the tag value array dedicated to thread n is returned. That is, among entries in the tag value array, the conversion result (the right array in FIG. 6) of the shared cache data value array indicated by the value (index) that indicates the address that stores the cache data corresponding to the tag value is the value to be acquired.

In addition, operations of functional blocks that construct the image processing system in this embodiment illustrated in FIGS. 7A and 7B can be executed by a program on a computer. That is, the CPU 31 in the image processing system loads a program stored in the ROM 32. Next, it is possible to implement the embodiment by executing each step of the program sequentially.

It should be noted that the embodiment described above does not limit scope of the present invention. It is possible to implement a multi-threading function that the print controller executes drawing threads and a bitmap image is generated concurrently in each of the drawing threads. In addition, it is possible to implement a multi-threading function that the communication controller executes drawing threads and a bitmap image is generated concurrently in each of the drawing threads.

In addition, it is possible that the image processing system includes multiple image forming apparatus and any one of the image forming apparatuses implements the function. The configuration of the image processing system in this embodiment is just an example, and it is possible to configure the image processing system in various ways depending on usage and purpose.

In this embodiment, it is possible to manage cache efficiently in multi-threading using two types of arrays, the tag value array dedicated to each thread and the cache data value array shared by all threads. The tag value array dedicated to each thread consists of the tag value and the value indicating the address that stores the cache data corresponding to the tag value. The cache data value array shared by all threads consists of the tag value and the cache data value corresponding to the tag value.

By using the tag value array dedicated to each thread, it is possible to provide the most appropriate cache to each thread and perform searching at high speed compared to a conventional method that uses the cache shared by all threads only. In addition, by using the cache data value array that stores data for the same tag values commonly, it is possible to minimize the memory size, and it takes only one calculation to acquire the calculation result from the tag value into the conversion result.

In the embodiment described above, an information processing system that can provide the most appropriate configuration of cache satisfying both the efficiency of searching through cache in multi-threading and the memory size is provided.

Numerous additional modifications and variations are possible in light of the above teachings. It is therefore to be understood that within the scope of the appended claims, the disclosure of the present invention may be practiced otherwise than as specifically described herein.

For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information processing system comprising:
circuitry to execute multiple threads that, in converting data, concurrently performs calculation required for a data conversion on an attribute including a type of the data; and
a memory to store the attribute associated with a converted value obtained by the calculation,
wherein the memory includes:
a storage area for the attribute, allocated to each of the multiple threads and to store the attribute associated with a value indicating an address that stores the converted value corresponding to the attribute; and
a storage area for the converted value, to be shared by all of the multiple threads and store the attribute associated with the converted value obtained by the calculation.

2. The information processing system according to claim 1, wherein the data is image data, and the data conversion is a bitmap conversion that converts the image data into a bitmap image.

3. The information processing system according to claim 1, wherein the circuitry determines whether or not a new attribute exists in the storage area for the attribute, and, if it is determined by the circuitry that the new attribute exists in the storage area for the attribute, instead of performing the calculation, uses the converted value stored in the storage area for the converted value corresponding to the value indicating the address that stores the converted value corresponding to the new attribute.

4. The information processing system according to claim 3, wherein, if the circuitry determines that the new attribute does not exist in the storage area for the attribute, the circuitry determines whether or not the new attribute exists in the storage area for the converted value, and, if it is determined by the circuitry that the new attribute exists in the storage area for the converted value, instead of performing the calculation, uses the converted value stored in the storage area for the converted value associated with the new attribute.

5. The information processing system according to claim 4, wherein, if it is determined by the circuitry that the new attribute does not exist in the storage area for the converted value, the circuitry performs the calculation required for the data conversion on the new attribute.

6. The information processing system according to claim 5, wherein a new converted value obtained by performing the calculation required for the data conversion on the new attribute is stored associated with the new attribute in place of a converted value whose frequency in use is the lowest stored in the storage area for the converted value.

7. The information processing system according to claim 6, wherein, in the storage area for the attribute, the new attribute is stored associated with a value indicating an address that the new converted value corresponding to the new attribute is stored.

8. A method of processing information performed by an information processing system, the method comprising:
executing multiple threads that, in converting predetermined data, concurrently performs calculation required for a data conversion on an attribute including a type of the predetermined data;
storing the attribute associated with a value indicating an address that stores the converted value corresponding to the attribute in a storage area for the attribute of a memory; and
storing the attribute associated with a converted value obtained by the calculation in a storage area for the converted value of the memory.

9. The method of processing information according to claim 8, wherein the data is image data, and the data conversion is a bitmap conversion that converts the image data into a bitmap image.

10. The method of processing information according to claim 8, the method further comprising:
determining whether or not a new attribute exists in the storage area for the converted value; and
obtaining, for use, the converted value stored in the storage area for the converted value corresponding to the value indicating the address that stores the converted value corresponding to the new attribute, instead of performing the calculation, if the determining determines that the new attribute exists in the storage area for the attribute.

11. The method of processing information according to claim 10, the method further comprising:
determining whether or not the new attribute exists in the storage area for the converted value; and
obtaining, for use, the converted value stored in the storage area for the converted value associated with the new attribute instead of performing the calculation if the determining determines that the new attribute exists in the storage area for the converted value.

12. The method of processing information according to claim 11, the method further comprising:
performing the calculation required for the data conversion on the new attribute if the determining determines that the new attribute does not exist in the storage area for the converted value.

13. The method of processing information according to claim 12, the method further comprising:
storing a new converted value obtained by performing the calculation required for the data conversion on the new attribute associated with the new attribute in place of a converted value whose frequency in use is the lowest stored in the storage area for the converted value.

14. The method of processing information according to claim 13, the method further comprising:
storing the new attribute in the storage area for the attribute associated with a value indicating an address that the new converted value corresponding to the new attribute.

15. A non-transitory, computer-readable recording medium storing a program that, when executed by one or more processors of an information processing system, causes the processors to implement a method of processing information, comprising:
executing multiple threads that, in converting predetermined data, concurrently performs calculation required for a data conversion on an attribute including a type of the predetermined data;
storing the attribute associated with a value indicating an address that stores the converted value corresponding to the attribute in a storage area for the attribute of a memory; and
storing the attribute associated with a converted value obtained by the calculation in a storage area for the converted value of the memory.

16. The non-transitory, computer-readable recording medium storing the program that, when executed by one or more processors of the information processing system, causes the processors to implement the method of processing information according to claim 15, wherein the data is image data, and the data conversion is a bitmap conversion that converts the image data into a bitmap image.

17. The non-transitory, computer-readable recording medium storing the program that, when executed by one or more processors of an information processing system, causes the processors to implement the method of processing information according to claim 15, further comprising:
determining whether or not a new attribute exists in the storage area for the converted value; and
obtaining, for use, the converted value stored in the storage area for the converted value corresponding to the value indicating the address that stores the converted value corresponding to the new attribute, instead of performing the calculation, if the determining determines that the new attribute exists in the storage area for the attribute.

18. The non-transitory, computer-readable recording medium storing the program that, when executed by one or more processors of an information processing system, causes the processors to implement the method of processing information according to claim 17, further comprising:
determining whether or not the new attribute exists in the storage area for the converted value; and
obtaining, for use, the converted value stored in the storage area for the converted value associated with the new attribute instead of performing the calculation if the determining determines that the new attribute exists in the storage area for the converted value.

19. The non-transitory, computer-readable recording medium storing the program that, when executed by one or more processors of an information processing system, causes the processors to implement the method of processing information according to claim 18, further comprising:
performing the calculation required for the data conversion on the new attribute if the determining determines that the new attribute does not exist in the storage area for the converted value.

20. The non-transitory, computer-readable recording medium storing the program that, when executed by one or more processors of an information processing system, causes the processors to implement the method of processing information according to claim 19, further comprising:
storing a new converted value obtained by performing the calculation required for the data conversion on the new attribute associated with the new attribute in place of a converted value whose frequency in use is the lowest stored in the storage area for the converted value.
